(19) United States
(12) Patent Application Publication
(10) Pub. No.: US 2016/0125292 A1
(43) Pub. Date: May 5, 2016

(54) APPARATUS AND METHOD FOR GENERATING PREDICTION MODEL

(71) Applicant: SAMSUNG SDS CO., LTD., Seoul (KR)

(72) Inventors: Ji Hyeon SEO, Seoul (KR); Jae Young LEE, Seoul (KR); Dong Min SHIN, Seoul (KR); Kyung Jun AN, Seoul (KR)

(73) Assignee: SAMSUNG SDS CO., LTD., Seoul (KR)

(21) Appl. No.: 14/926,286

(22) Filed: Oct. 29, 2015

(30) Foreign Application Priority Data
Oct. 30, 2014 (KR) 10-2014-0148998

(51) Int. Cl. G06N 5/02; G06N 99/00

(52) U.S. Cl. CPC G06N 5/022; G06N 99/005

(57) ABSTRACT

Disclosed herein are an apparatus for generating a prediction model and a method thereof. The apparatus for generating a prediction model from data composed of a plurality of instances each including one or more predictor values and a target value includes a pre-processing module configured to generate pre-processed target values by calculating weighted averages of the target values for a predetermined prediction period and subtracting the weighted averages from the target values, a prediction model generation module configured to calculate prediction values of the target values of the respective instances from the plurality of instances including the pre-processed target values, and a post-processing module configured to add the weighted averages, which are subtracted in the pre-processing module, to the prediction values of the target values of the respective instances.

### CROSS-REFERENCE TO RELATED APPLICATION

This application claims priority to and the benefit of Korean Patent Application No. 10-2014-0148998, filed on Oct. 30, 2014, the disclosure of which is incorporated herein by reference in its entirety.

### BACKGROUND

1. Field

Embodiments of the present disclosure relate to a technology for generating a prediction model to predict a result according to a situation that may occur in the future by analyzing past data.

2. Discussion of Related Art

A large various schemes are used for prediction models that predict a result according to a situation that may occur in the future by analyzing past data. Depending on a distribution of data and a relationship between features of data, data pre-processing processes and suitable predication schemes may be varied, and accordingly, the prediction accuracy may be varied.

Conventional prediction models, especially in a case of data that follows non-normal distribution, such as a data distribution excessively concentrated on a certain value, have a problem of low accuracy in predictions. In addition, in the case of sparse data, in which a distribution range of data values is broad and the emergence of values is scarce, existing prediction models have difficulty in increasing prediction accuracy, and a forcible increase in the prediction accuracy may cause an over-fitted model. Accordingly, there is limitation that the existing prediction model produces a high hit ratio only for well-structured ideal data.

### SUMMARY

The present disclosure is directed to a technology for improving prediction accuracy when a prediction model is generated using sparse data which follows non-normal distribution.

According to an aspect of the present disclosure, there is provided an apparatus for generating a prediction model from data composed of a plurality of instances each including one or more predictor values and a target value, the apparatus includes a pre-processing module configured to generate pre-processed target values by calculating weighted averages of the target values based on a predetermined prediction period and subtracting the weighted averages from the target values, a prediction model generation module configured to calculate prediction values of the target values of respective instances from the plurality of instances including the pre-processed target values, and a post-processing module configured to add the weighted averages, which are subtracted in the pre-processing module, to the prediction values of the target values of the respective instances.

The pre-processing module may calculate the weighted average of a target value based on a certain prediction period by using the target value of the certain prediction period, one or more adjacent target values which have differences with the certain prediction period within a predetermined range, and weight values of the target value of the certain period and the one or more adjacent target values.

The prediction model generation module may calculate the prediction values of the target values of the respective instances by performing a regression analysis on the plurality of instances including the pre-processed target values.

The prediction model generation module may include a partition unit configured to partition the plurality of instances into a predetermined number of sections based on the pre-processed target values and to assign different labels to respective partitioned sections, a classifier model generation unit configured to generate a classifier model from the plurality of instances assigned the labels and to calculate a degree of membership of each instance with respect to the label by using the classifier model, and a regression model generation unit configured to generate a regression model by performing a regression analysis on the degrees of membership and the pre-processed target values and to calculate the prediction values of the target values of the respective instances by using the regression model.

The partition unit may partition the plurality of instances such that the number of partitioned instances for each section is equal among the respective sections within a predetermined allowable error range.

The classifier model generation unit may generate the classifier model by using one of a Support Vector Machine algorithm, a Naive Bayesian Classification algorithm, and a Deep Learning algorithm.

According to another aspect of the present disclosure, there is provided a method for generating a prediction model from data composed of a plurality of instances each including one or more predictor values and a target value, the method includes a pre-processing operation of generating pre-processed target values by calculating weighted averages of the target values based on a predetermined prediction period and subtracting the weighted averages from the target values, a prediction model generating operation of calculating prediction values of the target values of respective instances from the plurality of instances including the pre-processed target values, and a post-processing operation of adding the weighted averages, which are subtracted in the pre-processing operation, to the prediction values of the target values of the respective instances.

The pre-processing operation may calculate a weighted average of a target value based on a certain prediction period by using the target value of the certain prediction period, one or more adjacent target values which have differences with the certain prediction period within a predetermined range, and weight values of the target value of the certain period and the one or more adjacent target values.

The prediction model generating operation may calculate the prediction values of the target values of the respective instances by performing a regression analysis on the plurality of instances including the pre-processed target values.

The prediction model generating operation may include a partitioning operation of partitioning the plurality of instances into a predetermined number of sections based on the pre-processed target values and assigning different labels to respective divided sections, a classifier model generating operation of generating a classifier model from the plurality of instances assigned the labels and calculating a degree of membership of each instance with respect to the label by using the classifier model, and a regression model generating operation of generating a regression model by performing a regression analysis on the degrees of membership and the pre-processed target values and calculating the prediction values of the target values of the respective instances by using the regression model.

The partitioning operation may partition the plurality of instances such that the number of partitioned instances of each section is equal among the respective sections within a predetermined allowable error range.

The classifier model generating operation may generate the classifier model by using one of a Support Vector Machine algorithm, a Naive Bayesian Classification algorithm, and a Deep Learning algorithm.

According to another aspect of the present disclosure, there is provided a computer program, combined with hardware, configured to generate a prediction model from data composed of a plurality of instances each including one or more predictor values and a target value, the computer program stored in a recording media to perform operations includes a pre-processing operation of generating pre-processed target values by calculating weighted averages of the target values for a predetermined prediction period and subtracting the weighted averages from the target values, a prediction model generating operation of calculating prediction values of the target values of respective instances from the plurality of instances including the pre-processed target values, and a post-processing operation of adding the weighted averages, which are subtracted in the pre-processing operation, to the prediction values of the target values of the respective instances.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating an apparatus for generating a prediction model according to an exemplary embodiment of the present disclosure;

FIG. 2 is a block diagram illustrating a detailed configuration of a prediction model generation module according to an exemplary embodiment of the present disclosure; and

FIG. 3 is a flow chart showing a method for generating a prediction model according to an exemplary embodiment of the present disclosure.

### DETAILED DESCRIPTION OF EXEMPLARY EMBODIMENTS

Exemplary embodiments of the present disclosure will be described in detail below with reference to the accompanying drawings. The following description is intended to provide a general understanding of the method, apparatus and/or system described in the specification, but it is illustrative in purpose only and should not be construed as limiting the present disclosure.

In describing the present disclosure, detailed descriptions that are well-known but are likely to obscure the subject matter of the present disclosure will be omitted in order to avoid redundancy. The terminology used herein is defined in consideration of its function in the present disclosure, and may vary with an intention of a user and an operator or custom. Accordingly, the definition of the terms should be determined based on overall contents of the specification. The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Prior to description of the exemplary embodiments of the present disclosure, meanings of terminologies used in this specification will be described.

A target may represent an attribute of an object to be predicted.

A predictor may represent a set of one or more attribute values used to predict the target.

A prediction period may represent a unit of a period for which a target is predicted, for example, a month, a week, a day, or the like.

Input data is a set of instances composed of a predictor and a target, and is divided into training data and test data. The training data is used to perform a learning for generating a prediction model. The test data is used to evaluate the performance of data derived from the training data.

Table 1 below represents an example of training data. In Table 1, each row represents each instance forming training data. As described above, each instance of training data is composed of a predictor which is an attribute value used for prediction and a target to be predicted, as does the test data.

The training data in Table 1 represents information about logistics and demand with respect to selling products in a certain distributor for a certain period. The logistics information is information about selling individual items in a certain distributor for a certain period, including item group, item, destination code, distributor code, year, week, and day, and is used as the predictor. Demand indicated as a target represents the number of certain items sold in a prediction period (the prediction according to the exemplary embodiment is a daily basis prediction), among items delivered from a certain distributor to a certain destination.

TABLE 1

| Predictors | | | | | | | | |
|---|---|---|---|---|---|---|---|---|
| Item | | Destination | Distributor | | | | | Target |
| Group | Item | code | code | Year | Week | Day | . . . | Demand |
| AA | AA- | 6234480 | 2126323 | 2013 | 1 | Tue. | . . . | 0 |
| | AH2NMHB | | | | | | | |
| AA | AA- | 3454063 | 2126323 | 2013 | 1 | Mon. | . . . | 11 |
| | BS5N11W | | | | | | | |
| . . . | . . . | . . . | . . . | . . . | . . . | . . . | . . . | 6 |
| . . . | . . . | . . . | . . . | . . . | . . . | . . . | . . . | 0 |
| . . . | . . . | . . . | . . . | . . . | . . . | . . . | . . . | 0 |
| . . . | . . . | . . . | . . . | . . . | . . . | . . . | . . . | 0 |
| . . . | . . . | . . . | . . . | . . . | . . . | . . . | . . . | 7 |
| . . . | . . . | . . . | . . . | . . . | . . . | . . . | . . . | 0 |
| AC_AX | AC- | 2124229 | 2126323 | 2013 | 35 | Fri. | . . . | 0 |
| | 347HPAWQ | | | | | | | |

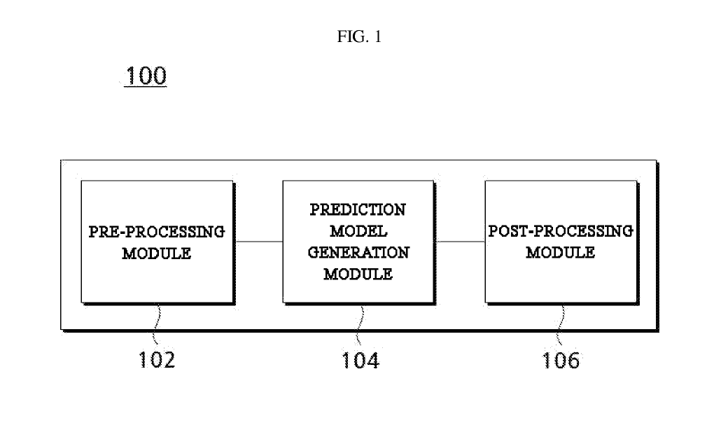

FIG. 1 is a block diagram illustrating an apparatus for generating a prediction model 100 according to an exemplary embodiment of the present disclosure. The apparatus for generating the prediction model 100 represents an apparatus for generating a prediction model from training data composed of a plurality of instances, each including one or more predictor values and a target value. Referring to FIG. 1, the apparatus for generating the prediction model 100 includes a pre-processing module (or a pre-processor) 102, a prediction model generation module (or a prediction model generator) 104 and a post-processing module (or a post-processor) 106. The pre-processing module 102 generates pre-processed target values by calculating weighted averages of target values based on a predetermined prediction period and subtracting the weighted averages from the target values.

The prediction model generation module 104 calculates prediction values of the target values of the respective instances from the plurality of instances including the pre-processed target values.

The post-processing module 106 adds the weighted averages, which have been subtracted by the pre-processing unit 102, to the prediction values of the target values of the respective instances.

The above modules of the apparatus for generating the prediction model 100 may be implemented with hardware. For example, the apparatus 100 may be implemented or included in a computing apparatus. The computing apparatus may include at least one processor and a computer-readable storage medium such as a memory that is accessible by the processor. The computer-readable storage medium may be disposed inside or outside the processor, and may be connected with the processor using well known means. A computer executable instruction for controlling the computing apparatus may be stored in the computer-readable storage medium. The processor may execute an instruction stored in the computer-readable storage medium. When the instruction is executed by the processor, the instruction may allow the processor to perform an operation according to an example embodiment. In addition, the computing apparatus may further include an interface device configured to support input/output and/or communication between the computing apparatus and at least one external device, and may be connected with an external device (for example, a device in which a system that provides a service or solution and records log data regarding a system connection is implemented). Furthermore, the computing apparatus may further include various different components (for example, an input device and/or an output device), and the interface device may provide an interface for the components. Examples of the input device include a pointing device such as a mouse, a keyboard, a touch sensing input device, and a voice input device, such as a microphone. Examples of the output device include a display device, a printer, a speaker, and/or a network card. Thus, the pre-processing module 102, the prediction model generation module 104 and the post-processing module 106 of the apparatus for generating the prediction model 100 may be implemented as hardware of the above-described computing apparatus.

Hereinafter, detailed configurations of the above described elements of the apparatus for generating the prediction model 100 in accordance with an exemplary embodiment of the present disclosure will be described.

Preprocessing of Training Data

The pre-processing module 102 generates pre-processed target values by calculating weighted averages of target values based on a predetermined prediction period and subtracting the weighted averages from the target values. The training data in accordance with exemplary embodiments of the present disclosure is sparse data following a non-normal distribution, in many cases data distribution is uneven and concentrated on a certain value. For example, since a target of a daily demand on Table 1 has a value of 0 when there are no orders placed, target values are concentrated on a value of 0 when compared to other values. According to an exemplary embodiment of the present disclosure, target values for respective prediction periods are subject to subtraction of weighted averages of the prediction period so that the target values are appropriately distributed to prevent the distribution of the target values from being excessively concentrated on a certain value.

The pre-processing module 102 according to an exemplary embodiment of the present disclosure may calculate a weighted average of a target value of a certain prediction period by using a target value of the certain period, one or more adjacent target values which have differences with the certain prediction period within a predetermined range, and weights of the target value of the certain period and the one or more adjacent target values. Here, the weight may be obtained by a Gaussian function, as described in Equation 1 below.

$$Weighted average of target value = \frac{{x}_{d} + {X}_{d - 1} g ( - dif ) f + {x}_{d + 1} ( dif ) f}{1 + g ( - dif ) f + g ( dif ) f} \qquad [ Equation 1 ]$$

(Herein, X_{d} is a target value of a corresponding period, X_{d-1} is a target value of a previous period, X_{d+1} is a target of a following period, diff is a difference between the corresponding period and the previous/following periods.)

Here, g(x) is a distribution function for calculating weights of targets of previous/following periods, for example, a Gaussian function may be used. If g(x) is provided as a Gaussian function, it may have the form of Equation 2.

$$g ( x ) = \frac{1}{\sqrt{2 πσ}} {e}^{- \frac{1}{2} {( \frac{x}{σ} )}^{2}} \qquad [ Equation 2 ]$$

(Herein, σ is a standard deviation.)

That is, as shown in Table 2, sales volumes of every Thursday is indicated as 0, but the sales volumes may be changed by pre-processing in consideration of sales of a previous day and a following day of each Thursday. Although the weighted average in Equation 1 is obtained in consideration of a previous period and a following period of each prediction period, the pre-processing module 102 according to another exemplary embodiment may calculate a weighted average in consideration of K targets before the corresponding prediction period and K targets after the corresponding prediction period.

As the weighted average is calculated above, the pre-processing module 102 may generate a pre-processed target value by subtracting a weighted average of a target value of each instance of the training data from the target value of each instance. Through the pre-processing, the pre-processing module 102 may remove a bias of sparse data in which the distribution of target values is excessively concentrated on a certain value, and may allow the target values to have a more uniform distribution.

For example, when assuming that a target of the training data is a daily sales volume of a certain product, Table 2 shows sales volumes of Wednesdays, Thursdays, and Fridays of the last three weeks.

TABLE 2

| Week | Day | Sales Volume |
|---|---|---|
| 1^{th} | Wed. | 13 |
| | Thur. | 0 |
| | Fri. | 4 |
| 2^{th} | Wed. | 2 |
| | Thur. | 0 |
| | Fri. | 5 |
| 3^{th} | Wed. | 7 |
| | Thur. | 0 |
| | Fri. | 5 |

A weighted average of Thursday of each week may be calculated as follows by using the sales volumes of Table 2 and Equation 1 described above.

Weighted Average of Thursday of 1^{st} week (m₁)=(0+g(−1)*13+g(1)*4)/(1+g(−1)+g(1))=2.428006

Weighted Average of Thursday of 2^{nd} week (m₂)=(0+g(−1)*2+g(1)*5)/(1+g(−1)+g(1))=0.999767

Weighted Average of Thursday of 3^{rd} week (m₃)=(0+g(−1)*7+g(1)*5/(1+g(−1)+g(1))=1.713886

In addition, a pre-processed sales volume of Thursday of each week may be calculated from the weighted average as follows:

Pre-processed target value of Thursday of 1^{st} week=0−2.428006=−2.428006

Pre-processed target value of Thursday of 2^{nd} week=0−0.999767=−0.999767

Pre-processed Target value of Thursday of 3^{rd} week=0−1.713886=−1.713886

Table 3 and Table 4 illustrate targets of training data and pre-processed target values (target′) generated from the target values, respectively.

TABLE 3

| ROW_ID | Col_1 | Col_2 | Col_3 | . . . | Target |
|---|---|---|---|---|---|
| 1 | | | | | 0 |
| 2 | | | | | 0 |
| 3 | | | | | 7 |
| . . . | | | | | . . . |
| 99 | | | | | 3 |
| 100 | | | | | 0 |

TABLE 4

| ROW_ID | Col_1 | Col_2 | Col_3 | . . . | Target′ |
|---|---|---|---|---|---|
| 1 | | | | | −0.6 |
| 2 | | | | | −4 |
| 3 | | | | | 4.8 |
| . . . | | | | | . . . |
| 99 | | | | | 0.6 |
| 100 | | | | | 0 |

Generation of Prediction Model

When pre-processing of the target value is finished, the prediction model generation module 104 divides the plurality of instances including the pre-processed target values into a plurality of sections, and performs a regression analysis using a degree of membership with respect to each section calculated by a classifier model, thereby calculating a prediction value of a target value of each instance.

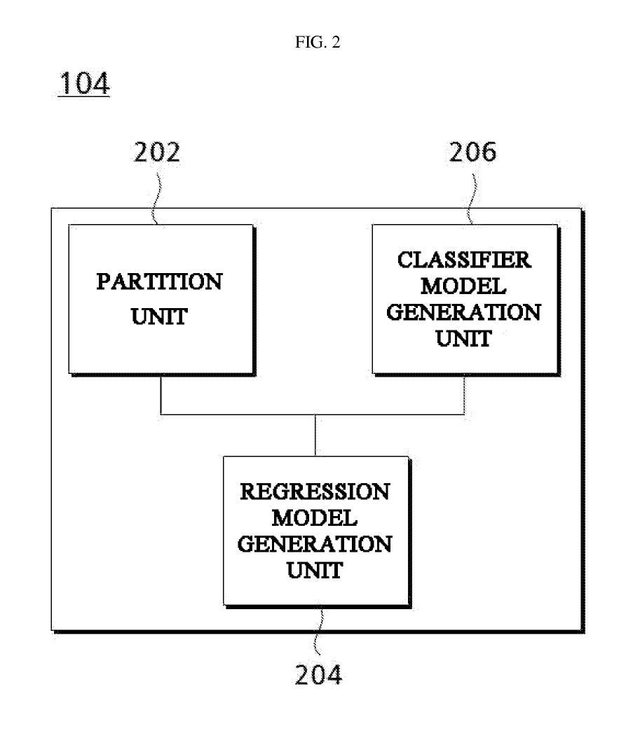

FIG. 2 is a block diagram illustrating a detailed configuration of the prediction model generation module 104 according to an exemplary embodiment of the present disclosure. Referring to FIG. 2, the prediction model generation module 104 may include a partition unit 202, a classifier model generation unit 204 and a regression model generation unit 206.

The partition unit 202 partitions the plurality of instances into a predetermined number of sections based on the target values subjected to pre-processing in the pre-processing module 102, and assigns different labels to the partitioned sections. Here, each label is a unique value representing the corresponding data section. The division may be achieved using techniques such as N-quantiles, Log Linear, and the like.

According to an exemplary embodiment of the present disclosure, the partition unit 202 may partition the plurality of instances such that an equal number of instances are included in each section. That is, the partition unit 202 may adjust a range of the target values for each section such that the number of instances allocated to each section is equal among the respective sections. Accordingly, a size of the range of the target values for each section may be different among the respective sections.

For example, when training data of Table 4 is partitioned into five sections as shown in Table 5 below, and different labels (A, B, C, D, and E) are assigned to the five sections, respectively, the result is shown as Table 6. In Table 6, the assigned label is stated in a column indicated as “target″”.

TABLE 5

| | | Number of pieces |
|---|---|---|
| Section | Range | of Data |
| A | −5~−3.5 | 23 |
| B | −3.5~0 | 17 |
| C | 0~0.7 | 19 |
| D | 0.7~5 | 20 |
| E | 5~100 | 21 |

TABLE 6

| ROW_ID | Col_1 | Col_2 | Col_3 | . . . | Target′′ |
|---|---|---|---|---|---|
| 1 | | | | | B |
| 2 | | | | | A |
| 3 | | | | | D |
| . . . | | | | | . . . |
| 99 | | | | | C |
| 100 | | | | | C |

When the number of instances of a section is referred to as “being equal” in accordance with the exemplary embodiment of the present disclosure, the number of instances of each section is not necessarily the same among the sections, and the number of instances of a section may be different within a predetermined range. In other words, the partition unit 202 may determine that the respective sections are equally partitioned if the number of instances included in each section is different among the respective sections within a predetermined allowable error range. For example, the partition unit 202 may partition a plurality of instances into four sections based on target values.

Section 1 (target value −2.5˜0): 21

Section 2 (target value 0˜1): 24

Section 3 (target value 1˜5): 19

Section 4 (target value 5˜80): 20

According to another exemplary embodiment of the present disclosure, the partition unit 202 may set ranges of target values by using an exponential function, and may partition the plurality of instances based on the ranges. For example, the partition unit 202 may partition ranges of target values as follows by using an exponential function.

Section 1: target value 0˜1

Section 2: target value 1˜10

Section 3: target value 10˜100

That is, the exemplary embodiment of the present disclosure is not limited to a particular partitioning method.

Thereafter, the classifier model generation unit 204 generates a classifier model from the plurality of instances assigned the labels, and calculates a degree of membership of each instance with respect to the label by using the classifier model. In accordance with an exemplary embodiment of the present disclosure, the classifier model generation unit 204 may generate the classifier model by using one of a Support Vector Machine algorithm, a Naive Bayesian Classification algorithm, and a Deep Learning algorithm. However, this is illustrative in purpose only, and the exemplary embodiment of the present disclosure is not limited to a particular classifier model. In addition, if necessary, the classifier model generation unit 204 may generate the classifier model by adding a distribution according to each label as a predictor.

Table 7 below shows a degree of membership of each instance generated using data of Table 6 by the classifier model generation unit 204. In Table 7, values of columns indicated as A, B, C, D, and E represent degrees of membership of instances with respect to labels.

| ROW_ID | A | B | C | D | E | Target′ |
|---|---|---|---|---|---|---|
| 1 | 0.08 | 0.7 | 0.15 | 0.05 | 0.02 | −0.6 |
| 2 | 0.65 | 0.3 | 0.02 | 0.02 | 0.01 | −4 |
| 3 | 0.04 | 0.05 | 0.06 | 0.7 | 0.15 | 4.8 |
| . . . | . . . | . . . | . . . | . . . | . . . | . . . |
| 99 | 0.1 | 0.1 | 0.6 | 0.1 | 0.1 | 0.6 |
| 100 | 0.01 | 0.06 | 0.9 | 0.02 | 0.01 | 0 |

Then, the regression model generation unit 206 generates a regression model by performing a regression analysis (correlation analysis) on the degree of membership and the pre-processed target value, and calculates a prediction value of a target of each instance using the regression model. The regression model generation unit 206 learns a regression model using input data that has a degree of membership of each label, which is output data of the classifier model generation unit 204, as a predictor. Here, if necessary, the regression model generation unit 206 may perform learning by adding a distribution of respective labels as a predictor. The regression model according to the exemplary embodiment of the present disclosure may be provided using a Regression tree, a Generalized linear model (GLM), and the like. However, this is illustrative in purpose and implementation of the regression model is not limited to a particular regression model.

Table 8 below illustrates prediction values of targets of respective instances generated by using data of FIG. 7.

TABLE 8

| ROW_ID | Prediction Value |
|---|---|
| 1 | −0.4 |
| 2 | −3.3 |
| 3 | 5 |
| . . . | . . . |
| 99 | 0.3 |
| 100 | 0.1 |

As described above, the prediction model generation module 104 in accordance with an exemplary embodiment of the present disclosure learns a classifier model capable of classifying labels by using N predictors, represents the training data as degrees of membership with respect to K labels, and uses the degrees of membership as input data used when generating a regression model. That is, the classifier model generation unit 204 converts a distribution of the training data not into the existing N predictors that are difficult to be clearly distinguished but into K predictors that are easy for a machine to clearly determine, and as the training data is represented as degrees of memberships for the K labels that are less than the number of predictors N (that is, K<N), an effect of a dimension of the training data being reduced occurs. According to the exemplary embodiments of the present disclosure, the degree of membership with respect to the label obtained through the classifier model is used as a meaningful characteristic derived from each predictor, thereby increasing the accuracy of prediction.

Post-Processing of Prediction Data

After the prediction model is generated in the above process, the post-processing module 106 performs a post-processing of data by adding the weighted averages, which have been subtracted by the pre-processing module, to the prediction values of the targets of the respective instances. That is, the post-processing module 106 restores the data distribution by adding the weighted averages, which were removed in the pre-processing of the prediction data, to prediction data of the regression model generated by the prediction model generation module 104.

Table 9 describes final prediction values generated by adding the weighted averages, which are removed in Table 4, to the prediction values of Table 8, and compares the final prediction values with the target values of Table 3.

TABLE 9

| | | Final Prediction |
|---|---|---|
| ROW_ID | Target | Value |
| 1 | 0 | 0.2 |
| 2 | 0 | 0.7 |
| 3 | 7 | 7.2 |
| . . . | . . . | . . . |
| 99 | 3 | 2.7 |
| 100 | 0 | 0.1 |

Meanwhile, the apparatus for generating the prediction model 100 according to the exemplary embodiment of the present disclosure may further include a test module (not shown). The test module substitutes test data for the model generated using the training data, and compares a prediction result of the test data with an actual result, thereby measuring the performance of the generated prediction model. The test data may have the same form as that of the training data.

The test module may measure the performance of the prediction model by using various types of performance measurement schemes. For example, the test module may use a Root Mean Square Error (RMSE) method to calculate the difference between a prediction value predicted by a learned model and a target value of test data, and measure the performance of the prediction model from the difference.

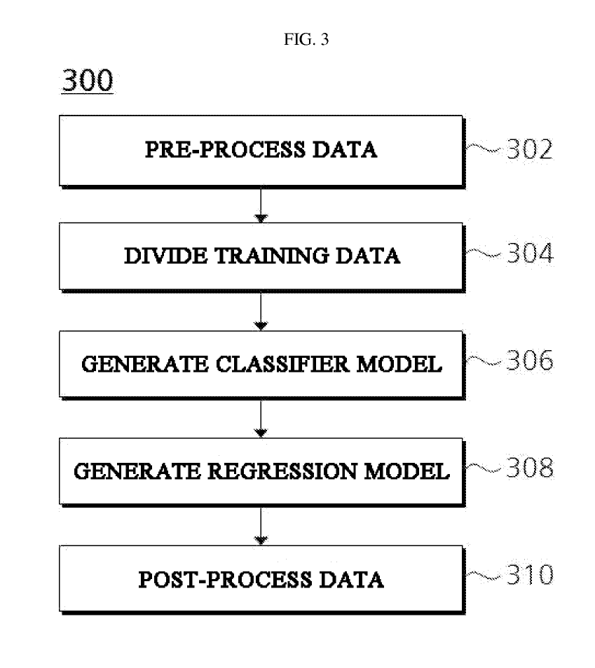

FIG. 3 is a flow chart showing a method for generating a prediction model 300 according to an exemplary embodiment of the present disclosure.

In operation S302, the pre-processing module 102 generates pre-processed target values by calculating weighted averages of target values based on a predetermined prediction period and by subtracting the weighted averages from the target values.

In operation S304, the partition unit 202 of the pre-processing module 102 partitions a plurality of instances into a predetermined number of sections based on the pre-processed target values, and assigns different labels to the partitioned sections.

In operation S306, the classifier model generation unit 204 of the pre-processing module 102 generates a classifier model from the plurality of instances to which the labels are assigned, and calculates a degree of membership of each instance with respect to the label by using the classifier model.

In operation S308, the regression model generation unit 206 of the pre-processing module 102 generates a regression model by performing a regression analysis on the degrees of membership and the pre-processed target factors, and calculates prediction values of the targets values for the respective instances by using the regression model.

In operation S310, the post-processing module 106 performs a post-processing which adds the weighted averages, which were subtracted by the pre-processing module, to the prediction values of the targets of the respective instances.

As is apparent from the above, according to the exemplary embodiments of the present disclosure, when a prediction model is generated by using sparse data following a non-normal distribution, a bias of the data is decreased by intentionally deforming a distribution of the data, and a dimension of the data is reduced by a classification result of a classifier model using labeling for each data section, that is, using a degree of membership of each section as an input of a regression model, so that the prediction accuracy of the prediction model can be improved.

According to the exemplary embodiments of the present disclosure, by combining a classifier model and a regression model where, first, a degree of membership of each data section is predicted through the classifier model and a prediction value is obtained through the regression model by using the degree of membership as an input of the regression model, thereby further increasing the prediction accuracy.

Meanwhile, the embodiments of the present disclosure may include a computer readable recording medium including a program to perform the methods described in the specification on a computer. The computer readable recording medium may include a program instruction, a local data file, a local data structure, or a combination of one or more of these. The medium may be designed and constructed for the present disclosure, or generally used in the computer software field. Examples of the computer readable recording medium include hardware device constructed to store and execute a program instruction, for example, a magnetic media such as hard disks, floppy disks, and magnetic tapes, optical media such as compact-disc read-only memories (CD-ROMs) and digital versatile discs (DVDs), magneto-optical media such as floptical disk, read-only memories (ROM), random access memories (RAM), and flash memories. In addition, the program instruction may include a machine code made by a compiler, and a high-level language executable by a computer through an interpreter.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. An apparatus for generating a prediction model from data composed of a plurality of instances each including one or more predictor values and a target value, the apparatus comprising:
a pre-processing module configured to generate pre-processed target values by calculating weighted averages of the target values based on a predetermined prediction period and subtracting the weighted averages from the target values;
a prediction model generation module configured to calculate prediction values of the target values of respective instances from the plurality of instances including the pre-processed target values; and
a post-processing module configured to add the weighted averages, which are subtracted in the pre-processing module, to the prediction values of the target values of the respective instances.

2. The apparatus of claim 1, wherein the pre-processing module calculates the weighted average of a target value based on a certain prediction period by using the target value of the certain prediction period, one or more adjacent target values which have differences with the certain prediction period within a predetermined range, and weight values of the target value of the certain period and the one or more adjacent target values.

3. The apparatus of claim 1, wherein the prediction model generation module calculates the prediction values of the target values of the respective instances by performing a regression analysis on the plurality of instances including the pre-processed target values.

4. The apparatus of claim 3, wherein the prediction model generation module includes:
a partition unit configured to partition the plurality of instances into a predetermined number of sections based on the pre-processed target values and to assign different labels to respective partitioned sections;
a classifier model generation unit configured to generate a classifier model from the plurality of instances assigned the labels and to calculate a degree of membership of each instance with respect to the label by using the classifier model; and
a regression model generation unit configured to generate a regression model by performing a regression analysis on the degrees of membership and the pre-processed target values and to calculate the prediction values of the target values of the respective instances by using the regression model.

5. The apparatus of claim 4, wherein the partition unit partitions the plurality of instances such that the number of partitioned instances of each section is equal among the respective sections within a predetermined allowable error range.

6. The apparatus of claim 4, wherein the classifier model generation unit generates the classifier model by using one of a Support Vector Machine algorithm, a Naive Bayesian Classification algorithm, and a Deep Learning algorithm.

7. A method for generating a prediction model from data composed of a plurality of instances each including one or more predictor values and a target value, the method comprising:
a pre-processing operation of generating pre-processed target values by calculating weighted averages of the target values based on a predetermined prediction period and subtracting the weighted averages from the target values;
a prediction model generating operation of calculating prediction values of the target values of respective instances from the plurality of instances including the pre-processed target values; and
a post-processing operation of adding the weighted averages, which are subtracted in the pre-processing operation, to the prediction values of the target values of the respective instances.

8. The method of claim 7, wherein the pre-processing operation calculates a weighted average of a target value based on a certain prediction period by using the target value of the certain prediction period, one or more adjacent target values which have differences with the certain prediction period within a predetermined range, and weight values of the target value of the certain period and the one or more adjacent target values.

9. The method of claim 7, wherein the prediction model generating operation calculates the prediction values of the target values of the respective instances by performing a regression analysis on the plurality of instances including the pre-processed target values.

10. The method of claim 9, wherein the prediction model generating operation includes:
a partitioning operation of partitioning the plurality of instances into a predetermined number of sections based on the pre-processed target values and assigning different labels to respective partitioned sections;
a classifier model generating operation of generating a classifier model from the plurality of instances assigned the labels and calculating a degree of membership of each instance with respect to the label by using the classifier model; and
a regression model generating operation of generating a regression model by performing a regression analysis on the degrees of membership and the pre-processed target values and calculating the prediction values of the target values of the respective instances by using the regression model.

11. The method of claim 10, wherein the partitioning operation partitions the plurality of instances such that the number of partitioned instances of each section is equal among the respective sections within a predetermined allowable error range.

12. The method of claim 10, wherein the classifier model generating operation generates the classifier model by using one of a Support Vector Machine algorithm, a Naive Bayesian Classification algorithm, and a Deep Learning algorithm.

13. A computer program, combined with hardware, configured to generate a prediction model from data composed of a plurality of instances each including one or more predictor values and a target value, the computer program stored in a recording media to perform operations comprising:
a pre-processing operation of generating pre-processed target values by calculating weighted averages of the target values for a predetermined prediction period and subtracting the weighted averages from the target values;
a prediction model generating operation of calculating prediction values of the target values of respective instances from the plurality of instances including the pre-processed target values; and
a post-processing operation of adding the weighted averages, which are subtracted in the pre-processing operation, to the prediction values of the target values of the respective instances.
